(19) United States
(12) Patent Application Publication
(10) Pub. No.: US 2007/0068728 A1
(43) Pub. Date: Mar. 29, 2007

(54) Circuit device and method for operating a hearing aid with time-adaptive behavior as well as therapy method for treating hearing problems in children

(75) Inventor: Andre Steinbuss, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/519,595

(22) Filed: Sep. 12, 2006

(30) Foreign Application Priority Data
Sep. 12, 2005 (DE) 10 2005 043 348.0

(51) Int. Cl. G01V 1/40

(52) U.S. Cl. 181/104

(57) ABSTRACT

The acceptance of hearing systems is to be improved. To this end there is provision for the control circuit for controlling a directional microphone circuit and/or a noise reduction circuit to feature a timer with which a parameter of the relevant circuit is able to be changed as a function of the time. Time-adaptive withdrawal of the effect of these circuits can for example enable an ear supplied with a new hearing aid to be slowly trained to localization and noise suppression.

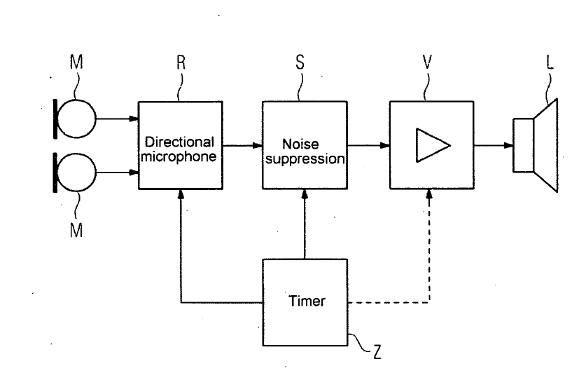

### CROSS REFERENCE TO RELATED APPLICATIONS

This application claims priority of German application No. 10 2005 043 348.0 filed Sep. 12, 2005, which is incorporated by reference herein in its entirety.

### FIELD OF THE INVENTION

The present invention relates to a circuit arrangement for operation of a hearing aid with a directional microphone circuit for obtaining a directional microphone signal and a control circuit for controlling the directional microphone circuit. In addition the present invention relates to a circuit device with a noise reduction circuit. Furthermore the present invention describes appropriate methods of explicitly picking up sound signals and of reducing interference noise in hearing aids.

### BACKGROUND OF THE INVENTION

The initial and subsequent provision of aids to hearing-impaired children is currently subject to controversy in discussions relating to the use of adaptive filters such as directional microphone and interference noise reduction. On the one hand the use of any type of adaptive filter is rejected in order to allow the child to have a normal and age-related development of the afferent nerve paths. Opposed to this is the view that it is precisely adaptive filters which should support new hearing aids provided in order to promote the acquisition of language and increase the acceptance of the hearing aid.

The basic problem which arises is that a person's provision requirements, especially a child's differ greatly over time. Thus the audiologist has previously always been required to aim to adapt the system to the patient's current needs. To do this he sets the parameters for the algorithms for directional microphone use and noise reduction within the framework of hearing aid provision in individual sessions with the hearing-impaired patient.

A circuit for operating a hearing aid with at least one variable operating parameter is known from patent application DE 195 42 961 C1. The operating parameter setting of an initial situation as well as that of a target situation is defined in a memory arrangement. A control unit is able to be used to adapt the operating parameter setting of the initial situation over a specific period of time to the operating parameter setting of the target situation. Operating parameters include the gain, the threshold value and the regulation time of a compression circuit, the output level and the frequency response.

A hearing aid is also known from publication EP 1 208 723 B1 in which parameters are modified in steps from a start point to and end point, depending on a trigger signal.

### SUMMARY OF THE INVENTION

The object of the present invention is thus to propose a circuit arrangement which leads to better acceptance of a hearing aid or a hearing device. In addition a corresponding method is to be specified.

In accordance with the invention this object is achieved by a circuit arrangement for operating a hearing aid with a directional microphone circuit for obtaining a directional microphone signal and a control circuit for controlling the directional microphone circuit, with the control circuit featuring a timer with which a parameter of the directional microphone circuit can be modified as a function of time.

Furthermore there is provision in accordance with the invention for a method for picking up noise signals for a hearing aid by obtaining a directional microphone signal from microphone input signals with a parametrizable directional microphone function, and making automatic modification of at least one parameter of the directional microphone dependent on time.

In an advantageous manner it is thus possible to automatically vary the effect of a directional microphone circuit over time. This promotes the acceptance of the hearing aid, since the hearing aid can be set initially in a way that patient finds comfortable. The target setting of the hearing aid is only then to be reached over the course of time. The automatic system enables repeated trials by the audiologist to be avoided.

In a preferred application the directional effect of the directional microphone of the hearing aid is able to be successively reduced automatically by the directional microphone circuit down to a predetermined end setting. This enables the patient's hearing to be trained so that it becomes directionally selective.

In a specific embodiment of the inventive circuit arrangement a signal processing circuit is connected to the directional microphone circuit, and the said parameter of the directional microphone circuit is able to be modified at the same time as the frequency response and/or the compression of the signal processing circuit. This means that, as the directional effect changes, other parameters and especially the frequency response or the compression can be also be changed automatically.

To achieve the above-mentioned object, there is also provision for a circuit arrangement for operating a hearing aid with a noise reduction circuit for reducing the noise components of a useful signal and a control circuit for controlling the noise reduction circuit, whereby the control circuit features a timer with which a parameter of the noise reduction circuit can be changed as a function of time.

Accordingly a method is also provided for reducing the interference sound in a hearing aid by filtering a raw signal with a parametrizable filter function, and automatic modification of at least one parameter of the filter function depending on time.

Thus, in accordance with the present invention it is also possible to vary the noise reduction or suppression over time according to a predetermined scheme. The acceptance of the hearing aid can also be improved because of the fact that the hearing is able to be set so that the interference noise suppression with the new hearing aid approximately corresponds to the interference noise suppression with the old hearing aid or without a hearing aid. The interference noise suppression can then just be set to the desired target over the course of time.

Preferably the parameter of the noise reduction circuit is the control level. This enables the level of the interference noise to be controlled in a suitable manner without in principle modifying the interference noise algorithm.

Noise reduction can be successively reduced automatically by the noise reduction circuit down to a predetermined end setting. This again has the advantage of enabling hearing to be trained in respect of selective hearing without excessive demands initially being imposed on the patient.

The change over time in the level of interference noise reduction can for example be combined with a change in the frequency response or the compression of the signal processing circuit. Specifically the variation over time of the noise reduction can also be combined with the directional microphone effect. This enables a major part of the setting options of the hearing system to be designed to be adapted over time.

Possible applications of the present inventions not only exist for hearing aids but also for any other hearing devices such as headsets and such like.

### BRIEF DESCRIPTION OF THE DRAWINGS

The present invention will now be explained in greater detail with reference to the enclosed drawing which shows a basic circuit diagram of the inventive hearing aid.

### DETAILED DESCRIPTION OF THE INVENTION

The exemplary embodiment described in greater detail below represents a preferred embodiment of the present invention.

In accordance with the example shown in the figure, a directional microphone circuit R processes the signals of two microphones M into one directional microphone signal which is fed to a noise suppression unit S. After the noise suppression unit S the noise-suppressed signal is fed in the usual way to an amplifier V which further amplifies the signal for a loudspeaker L.

Both the directional microphone circuit R and also the noise suppression are adaptive. This means that at least one parameter of the corresponding algorithms is variable. In the present case this at least one parameter is modified over time with the aid of a timer Z. Accordingly the microphone circuit R and the noise suppression unit S are activated by the timer Z as is shown sketched in the figure. If need be, the amplifier V can also be activated by the timer Z.

Overall the hearing system thus behaves in a time-adaptive manner and does this specifically in respect of the noise suppression and the directional microphone. For the actual case of provision of hearing aids to children, the control level and/or further parameters of the adaptive algorithms can be corrected adaptively over time by the hearing system. The basis of hearing aid provision would in this case be a basic setting with activated noise suppression and directional microphone, with the effectiveness of these algorithms being successively reduced within the framework of the acclimatization phase by the hearing system. Finally and end setting specified by the audiologist, e.g. the OFF setting, is reached.

The inventive time-adaptive reduction of the adaptive filter allows the provision of new hearing aids to children at the beginning of hearing aid provision to be supported, in that the ear provided with the new hearing aid is slowly trained to localization and noise suppression. Individual adaptation of these algorithms as part of individual sessions at the audiologist is no longer necessary in this case. The reason for this lies in the fact that the hearing system supports the acclimatization to the hearing system and successively reduces the effectiveness and control level of the adaptive filter over a predetermined period of time.

The hearing ability of children, like many other functions of their bodies, is at the stage of development and thereby mostly (still) very capable of learning and adaptation. There is an approach to therapy for vision impairment for example which, especially with children, but also with grown-ups, aims to dispense with a vision aid over the medium or long term or at least only require support which is as weak as possible in the form of spectacles etc. The basic idea of such a therapy is to utilize the capability of the eye to improve itself by “self-correction” within specific limits and thereby to avoid or at least to ameliorate any necessary correction using optical aids. This can be achieved by a “sight school” in which a patient learns sight exercises which improve the natural sight ability of the eye step by step.

The present invention now also leads to a therapy method for treatment of hearing impairments in children in which the child is initially provided with a hearing aid which features a directional microphone or a basic setting up with activated noise suppression. A microphone circuit for controlling the directional microphone and a noise suppression unit are activated by the timer which modifies at least one parameter of a noise suppression algorithm or the directional microphone as a function of time. The timer is designed so that the parameters are changed over time in such a way that a successive reduction of the noise reduction or of the directional effect is produced. This can be undertaken until such time as the noise reduction or the directional effect is no longer present. This has the advantage that the child's hearing is trained step-by-step in respect of selective hearing. In the ideal case the child no longer needs a hearing aid any more after a therapy phase with a hearing-aid.

In summary the proposed therapy approach for treating hearing problems in children can be presented as follows:

Supply of a hearing aid to a pediatric hearing patient;

Activation of an initial setting for a noise reduction of the hearing aid or a directional effect of the directional microphone;

Step-by-step withdrawal of the noise reduction or the directional effect by automatic modification of a parameter or of the noise reduction or of the directional microphone over time during a therapy phase; and

Achieving a desired end setting of the parameter after completion of the therapy phase, whereby the end setting is either a deactivated noise reduction or at least a reduced noise reduction compared to the initial setting or a deactivated directional effect or at least a reduced directional effect compared to the initial setting.

1-15. (canceled)

16. A circuit arrangement for a hearing aid, comprising:
a directional microphone circuit which processes a microphone signal from the hearing aid into a directional microphone signal, the directional microphone circuit having a parameter;
a first control circuit which controls the directional microphone circuit; and
a first timer arranged in the first control circuit which modifies the parameter as a function of time.

17. The circuit arrangement as claimed in claim 16, wherein the parameter of the directional microphone circuit is a directional effect of the directional microphone signal.

18. The circuit arrangement as claimed in claim 17, wherein the directional effect is automatically successively reduced by the directional microphone circuit to a predetermined end setting.

19. The circuit arrangement as claimed in claim 18, wherein a first signal processing circuit is connected to the directional microphone circuit which modifies other parameters of the hearing aid when the directional microphone effect is modified.

20. The circuit arrangement as claimed in claim 19, wherein the other parameters of the hearing aid is a frequency response or a compression of the hearing aid.

21. The circuit arrangement as claimed in claim 16, wherein the circuit arrangement comprises:
a noise reduction circuit which reduces a noise component of the directional microphone signal,
a second control circuit which controls the noise reduction circuit, and
a second timer arranged in the second control circuit which modifies a parameter of the noise reduction circuit as a function of time.

22. The circuit arrangement as claimed in claim 21, wherein the first and the second control circuit is a unitary control circuit.

23. The circuit arrangement as claimed in claim 21, wherein the parameter of the noise reduction circuit is a noise level.

24. The circuit arrangement as claimed in claim 23, wherein the noise level is automatically successively reduced by the noise reduction circuit to a predetermined end setting.

25. The circuit arrangement as claimed in claim 21, wherein a second signal processing circuit is connected to the noise reduction circuit which modifies a frequency response or a compression of the hearing aid when the noise level is modified.

26. The circuit arrangement as claimed in claim 25, wherein the first and the second signal processing circuit is a unitary signal processing circuit.

27. The circuit arrangement as claimed in claim 26, wherein the unitary signal processing circuit comprises an amplifier of the hearing aid.

28. A method for operating a hearing aid, comprising:
processing a microphone input signal of the hearing aid into a directional microphone signal; and
automatically modifying a parameter of the directional microphone signal as a function of time.

29. The method as claimed in claim 28, wherein the parameter of the directional microphone signal is a directional effect of the directional microphone signal which is automatically successively reduced to a predetermined end setting and a frequency response or a compression of the hearing aid is modified simultaneously.

30. The method as claimed in claim 28, wherein a raw signal of the hearing aid is filtered by a filtering function and a parameter of the filter function is automatically successively reduced to a predetermined end setting as a function of time.

31. The method as claimed in claim 30, wherein a frequency response or a compression of the hearing aid is modified simultaneously when the parameter of the filter function is modified.

32. The method as claimed in claim 30, wherein the raw signal of the hearing aid is the directional microphone signal.

33. A therapy method for treating a hearing-impaired child, comprising:
providing a hearing aid to the hearing-impaired child;
activating an initial setting for a noise reduction of the hearing aid;
successively decreasing the noise reduction by automatically modifying a parameter of the noise reduction over a period of time during a therapy phase; and
reaching an end setting of the parameter after completing the therapy phase.

34. The method as claimed in claim 33, wherein the ending setting is a deactivated or a reduced noise reduction compared to the initial setting.

35. The method as claimed in claim 33,
wherein an initial setting for a directional effect of a directional microphone of the hearing aid is activated,
wherein the directional effect is successively decreased by automatically modifying a parameter of the directional effect over a period of time during a therapy phase to reach an end setting of the parameter after completing the therapy phase, and
wherein the end setting is a deactivated or a reduced directional effect compared to the initial setting.
